(19) United States
(12) Patent Application Publication
(10) Pub. No.: US 2014/0300077 A1
(43) Pub. Date: Oct. 9, 2014

(54) Ride n' Grow Children's Bicycle System

(71) Applicant: Thomas Ellis Coghill, JR., Deerfield Beach, FL (US)

(72) Inventor: Thomas Ellis Coghill, JR., Deerfield Beach, FL (US)

(21) Appl. No.: 13/734,932

(22) Filed: Apr. 8, 2013

(51) Int. Cl. B62K 3/02

(52) U.S. Cl. CPC B62K 3/02
USPC 280/259

(57) ABSTRACT

The present invention is in the technical field of sporting and recreation. More particularly, the present invention is in the technical field of children's bikes. Conventional children's bikes last only a short time because the children outgrow them and or no longer find the style of the bike appealing. It is costly and time consuming to keep up with a child's needs and also his ever-changing tastes in trends. The present invention is a complete response to this issue. The present invention is a bicycle with a frame that has been designed to allow all sizes of wheel diameters to work on the same bike. The tires can be changed and the look of the bicycle can also be changed. Thus as a child grows, the bike can grow with him.

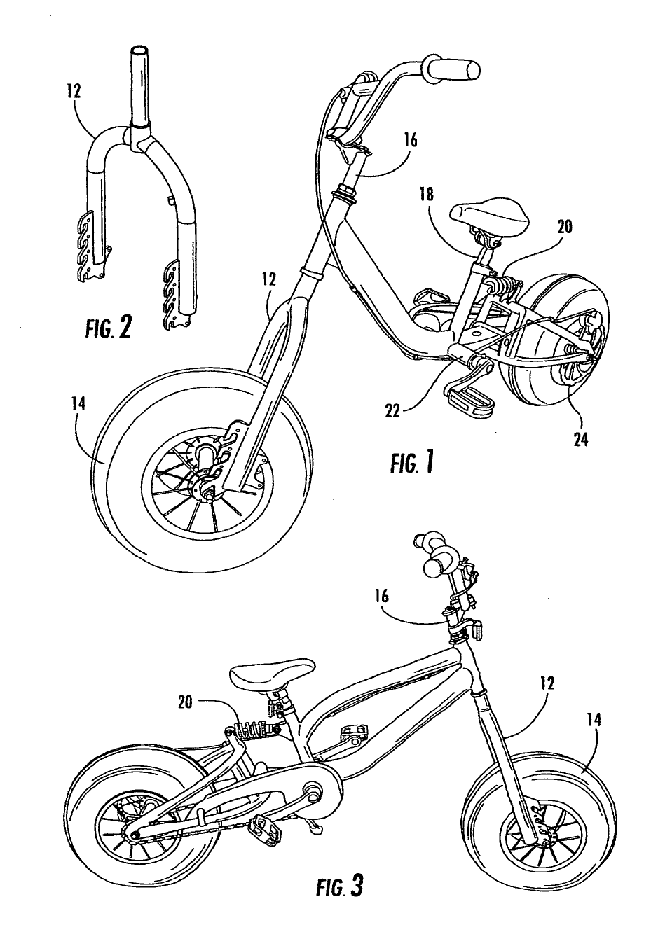

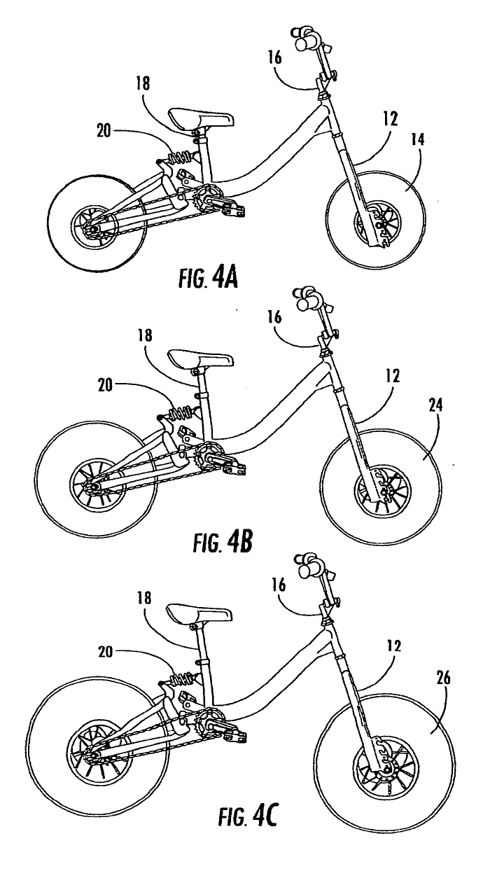

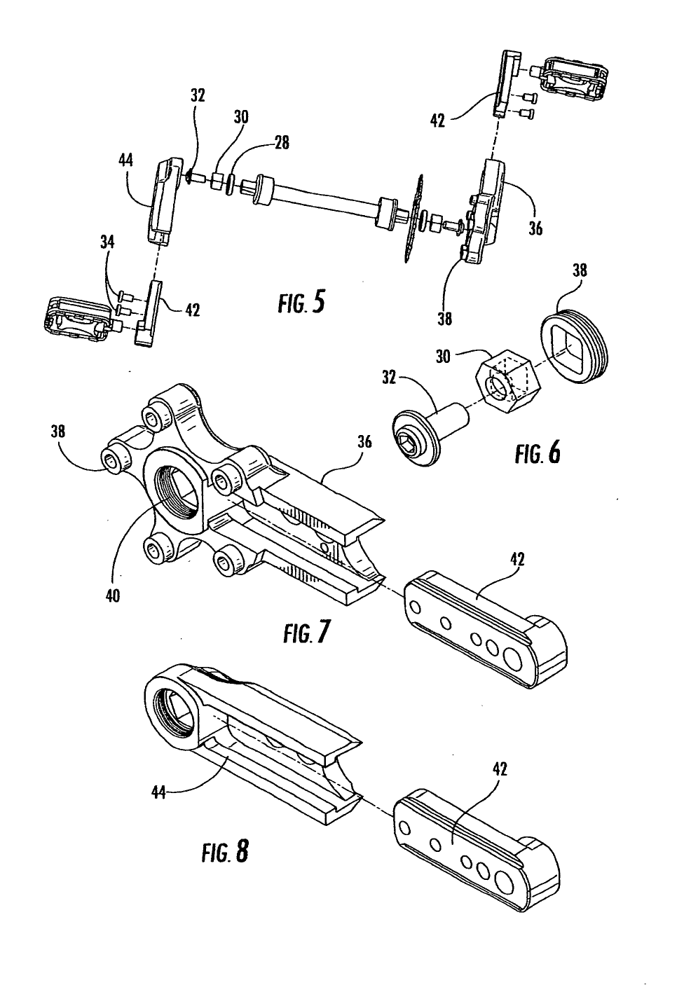

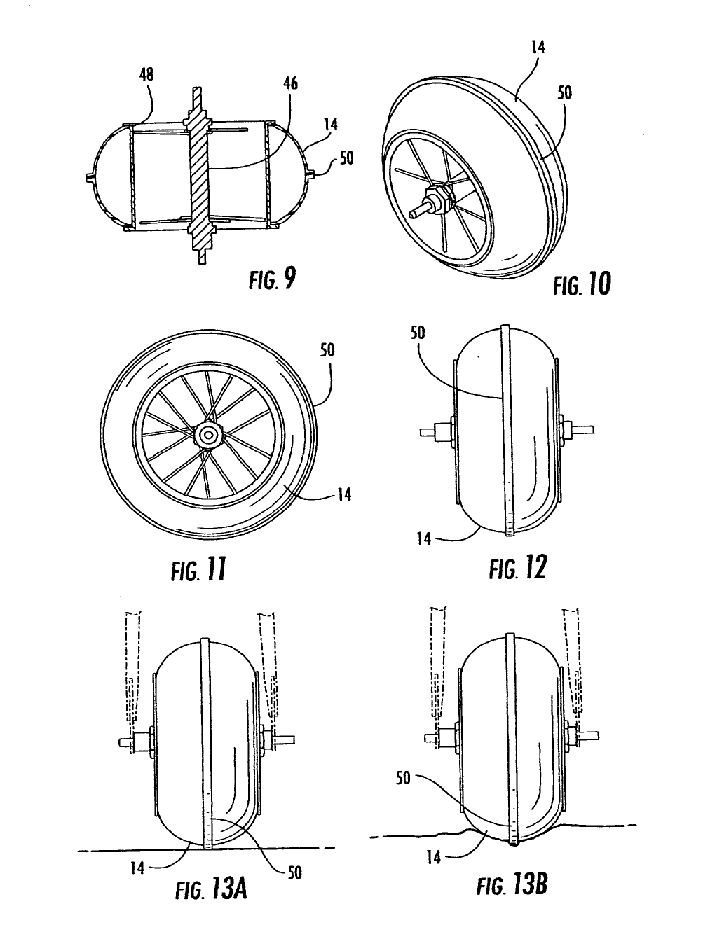

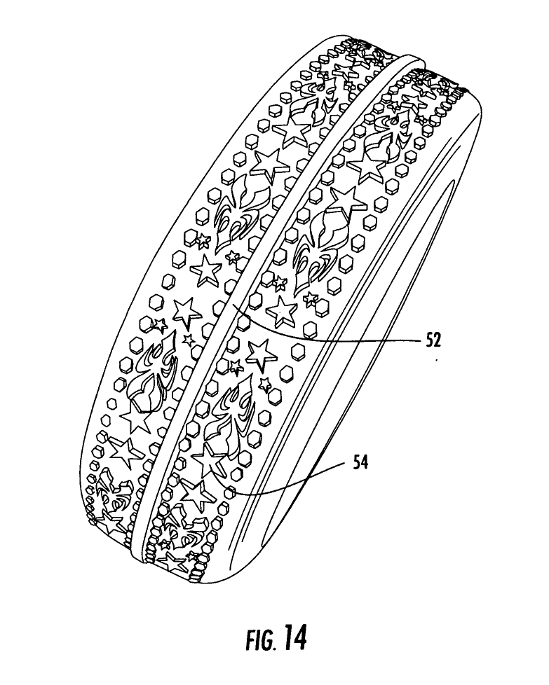

I am claiming the filing date Jan. 6, 2012 of Provisional Application #61/583,731

### CROSS-REFERENCE TO RELATED APPLICATIONS

Fat Tire Technology; Provisional Application #61/516,381

Claiming filing date Jan. 6, 2012 of Provisional Application #61/583,731

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of sporting and recreation. More particularly, the present invention is in the technical field of children's bikes. Conventional children's bikes last only a short time because the children outgrow them and or no longer find the style of the bike appealing. It is costly and time consuming to keep up with a child's needs and also his ever-changing tastes in trends. The present invention is a complete response to this issue. The present invention is a bicycle with a frame that has been designed to allow all sizes of wheel diameters to work on the same bike. The tires can be changed and the look of the bicycle can also be changed. Thus as a child grows, the bike can grow with him.

### SUMMARY OF THE INVENTION

The present invention is a bike with a frame that has been designed to allow all sizes of wheel diameters to work on it. In essence, the design of this bike accommodates the growing child by simply changing the tires to accommodate the child's needs.

This bike has a one-size rim and hub system that allows the consumer to install all different sized tires resulting in different size diameter wheel systems. The bike frame is designed to allow all sizes of wheel diameters to work on the same bike. When the child grows too large for the bike, the tires need only be switched out and the bike will once again be the correct size for the child. The tires are switched easily with the unique crank-arm system. The tires used are called “fat tires” and there is a provisional application on file for these tires. The name of the tire is “Fat Tire Technology” and it can be found in Provisional Application #61/516,381.

The crank arm system has it's own crank puller. This crank puller contains an Allen head screw that, once turned, presses the crank arm off. Each set of crank arms and bottom bracket spindles (axles) have a tapered attachment that upon tightening the bolt down, the crank arm completely locks into place. However, when this bolt is taken off, the crank arm is pressed on and cannot be taken off. As the bolt on this crank system is unscrewed, it presses the crank arm off. This bike frame also has a complete system that allows the bike's arm length to be made longer as the child grows. The arm has 3 settings: 90 mm length, 110 mm length and 130 mm length. This same arm can be used on any bike to allow the crank set to be adjusted. The frame and crank set up allow the crank arms to be easily rotated from 180 degrees off to parallel. This then allows the crank set to be locked onto the frame and the bike now has foot pegs instead of crank arms. In essence the bike starts off as a balance bike and then, as the child learns, the bike changes back to a pedal bike.

The frame and fork design is such that its geometry allows all of the parts including wheel size, crank arm length, seat post length and front steering system height and position to change. This design and its geometry allow this bike to accommodate to any size child or later to an adult. This bike has a fat wheel system with a 6″ wide wheelbase to allow the bike to have stability where it can almost balance itself. This stability makes it easy for a child to learn to ride without training wheels. The same stability lends itself to allowing older adults to ride without fear and with complete stability. Also, the skins of the wheels on these bikes can be changed to different designs. This allows the child to change the look of the bike along with the size of bike.

### DETAILED DESCRIPTION OF THE INVENTION

The present invention is a child's bicycle that can be altered in such a way as to literally grow with the child. The tires on the bicycle are 5 times the average width of a child's bicycle tire. There are 3 different size tires used with this bicycle. They are 5″ by 12″, 5″ by 16″ and 5″ by 20″.The tire's stabilizing function and footprint may be increased even more with pressure reduction.

This bicycle has been designed to use a specially engineered interchangeable wheel system. The center wheel or rim is only 6″ in diameter, which means that in order to suit the size of the growing child, the parent need only replace the tires on the bicycle. These tires will be available in a minimum of 3 different diameters, which will change the bicycles off the ground height in 2″ increments. Therefore, this all-in-one bicycle can use 12″ inch diameter tires and or wheels for children aged 2-4 years, 16″ inch diameter tires and or wheels for children aged 5-8 years and 20″ inch diameter tires and or wheels for children aged 9-10 years.

This bicycle comes with fat tire system technology, which is a 16″ by 5″ rim, hub and tire/tube. This technology adds to the bicycle's stability and ease of riding. This bicycle will utilize the Tommisea bicycles frame/fork design to allow for the 5″ wide tire, hub and rims designed for this bicycle. The fork on the bicycle will be made to accept the 16″ by 5″ rim, hub, and tire/tube system. This bike will have a minimum of 140 mm clearance side post to side post. It will have a standard stem, headset, and handle bar design. The frame will have a single bottom tube to go up from stem tube to the bottom bracket/seat post tube.

The frame's tube between bottom bracket tube and chain stay extra wide and the rear fork will be a single tube to allow chain clearance of the 16″ by 5″ tires and to align parallel and straight to the rear hub sprocket. The bottom bracket will be a minimum of 125 mm to allow the sprocket chain system to clear the 5″ wide tire and to allow for perfect alignment of the chain. The front chain ring will be a small size, approximately 30 T. The crank arms will also be shorter to allow for the young child to peddle with ease. The pedals will be standard, but easily removable to allow them to be removed for the young rider's initial training. These will be replaced when the child is ready to start peddling and riding the bike himself. These pedals will be easily removed to allow the child to begin learning. The child is then able to walk the bicycle until he is ready to start peddling.

The seat post will be of standard child bike's length with a standard seat post and seat that are specifically designed to suit either a girl or a boy rider. The rear chain stay and the rear fork system will be extra wide and long to allow for the 16″ by 5″ rim, hub and tire/tube system. This rear fork will allow for standard, extra wide, single speed coaster bike hub and its hub will have a single speed coaster brake attachment. The rear hub will be a single speed coaster brake steel or stainless steel hub with a low gearing to allow for riding in sandy soil, mud, grass, dirt, or even hard surfaces with ease.

This bicycle has an elongated Frame/Fork system allowing the top of the seat tube to be almost equal to the smallest tire heights. The seat or post can be raised as the child grows, constantly being adjusted to fit the child's size. The handlebars will raise equally with the change in the wheel or tire diameter and the front stem can be extended to elevate the handlebars to any required height adjustment.

The wider width of the tire, also known as the fat tire, allows the child rider to learn or ride on a more forgiving terrain. Soft terrain gives the child more strength and allows the child to fall on a more soft terrain rather than falling on pavement, for example. The less pain a child encounters while learning to ride a bicycle, the quicker he will learn how to ride a bicycle. No other child's bicycle is designed with this type of tire that is 5″ in width and is made from a spongy rubber. These tires allow for walking or riding on soft sandy soil, soft soil, snow grass, carpet or virtually any other type of terrain.

Other benefits of these tires are that the wide, soft tires can be deflated just like a large truck tire. This feature allows the tire to make a larger footprint thus helping the child to balance without the use of training-wheels. This young child can learn how to ride a bike from the day he starts merely by walking the bike until he is ready to peddle. Also, these fat tires have a system which allows you to change the tread on the bicycle to produce different designs in the sand, soft dirt, mud, snow or even with a water washable die on a hard surface. The designs are on the rear tire treads. A button to the smooth, non-treaded tires will attach these treads. These designs are colorful and standout against the black ground of the tire. The treads can be of designs, words, letters, messages, shapes and anything else that may appeal to a child. These treads are easily changed and will allow the child to learn shapes, words, designs, animals and even how to spell.

The fat tire low gear system allows this bicycle to be ridden on any surface, especially soft surfaces such as sand, soft dirt, grass, carpet or any soft terrain which allows the child to have a soft, safe area in which to learn to ride his bike. Children are prone to falling off of bicycles as they learn how to ride and this system allows them to do so without the repercussion of being hurt. Lastly the treads can be hollow to allow a parent to inject temporary die into them allowing the child to make actual prints on a hard surface.

The frame, fork, seat post, handle bars and stem can be made from aluminum, steel or plastic or from any other light weight corrosion resistant material that can withstand any type of environment or weather including sand, snow, dirt or muddy roads. This bicycle is designed with coaster brakes and front hand brakes. This brake design will allow a child to walk or to run without pedals while still allowing him to stop. The child will have both braking systems available to him as he learns to peddle and to ride. This bicycle has an absolutely unique style and shape. It has a chopper like look and it has fat tire technology. The fat tires that are used in this bicycle have the capability of being changed by simply changing the tread on the tire. This allows the child to change the look of the bike and the tread marks the bicycle makes while accommodating to the size bicycle the child needs. This bicycle has 2 to 3 times the usable life for the child because of the ability of the bicycle's seat, handle bar and tire to be adjusted to the child's needs. This bicycle will be the only bicycle a parent will ever have to buy for their child. The bicycle is built such that training wheels can also be added to it.

The advantages of the present invention include, without limitation, that this is the only bicycle a child will need from the time of learning how to ride a bike until adulthood.

While the written description above of the present invention enables one of ordinary skill to make and use what is considered at the present to be the best mode thereof, those of ordinary skill will understand and appreciate the existence of variations, combinations, and equivalents of the specific embodiment, method, and examples herein. Therefore the present invention should not be limited by the above described embodiment, method, and examples, but by all embodiments and methods within the scope and spirit of the invention as claimed.

1) A bicycle comprised of:
a bicycle frame with a single bottom tube to go up from a stem tube to a bottom seat post tube;
a fork on the bicycle that will be made to accept at least a 20″ by 5″ rim, hub, and tire/tube system;
four drop out adjustments to allow the front wheel height to change by adjusting the drop outs;
a tube in the bicycle's frame that lies between a bottom bracket tube and a chain;
said bottom bracket being a minimum size of 150 mm to allow a sprocket chain system to clear at least a 6″ wide tire and to allow for perfect alignment of a chain;
a rear fork comprised of a single tube to allow chain clearance of at least a 20″ by 6″ tires and that aligns parallel and straight to a rear hub sprocket;
a front chain ring will be any size to allow for any gearing for this bike;
crank arms that are 170 mm at most than on an adult bike;
a seat post;
handle bars;
a stem;
a headset;
standard bicycle pedals that can be removed
rear disc brake with front hand brake grip;
front disc brake;
a rear chain stay and a rear fork system that are wider and longer than an average chain and rear fork to allow for at least a 20″ by 5″ rim, hub and tire/tube system with the rear fork allowing for standard, extra wide, or single speed coaster bike hubs, the hub which will have a single speed or multi speed with disc brake attachment being comprised of any material or a stainless steel hub with a low gearing or multi gear;
a one-size rim and hub system that allows for installation of all different sized tires, which results in a different size diameter wheel system and for all sizes of wheel diameters to work on the same bike; and
a minimum of 210 mm clearance from a side post to another side post. The rim side wall will be removable to allow the tire to easily slide on and off.

2) The bicycle of claim 1, further with tires that may be switched through use of a crank arm system, which is compromised of:
a crank puller that contains an Allen head screw that, once turned, presses the crank arm off;
crank arms and bottom bracket spindles that have a tapered attachment that upon tightening the bolt down, the crank arm completely locks into place and upon this bolt being taken off, the crank arm is pressed on and cannot be taken off, further, as the bolt on this crank system is unscrewed, it presses the crank arm off.

3) The bicycle of claim 2, further, the bicycle frame being comprised of a system that allows the bike's arm length to be made longer as the child grows as follows:
The arm of the bicycle can be any length; and said arm can be used on any bike to allow the crank set to be adjusted.

4) The bicycle of claim 3, further the frame and crank allow for the crank arms to be rotated from 180 degrees to parallel, in turn allowing the crank set to be locked onto the frame and the bicycle having foot pegs instead of crank arms thus allowing what starts off as a balance bike to be converted to a pedal bike.

5) The bicycle of claim 4, further the frame and fork design allowing all of the parts the bicycle is comprised of to be altered including wheel size, crank arm length, seat post length and front steering system height and position to change.

6) The bicycle of claim 5, further, comprised of at least a 5″ wide wheelbase to allow the bike to have stability.

7) The bicycle of claim 6, further the frame, fork, seat post, handle bars and stem being comprised of aluminum, steel or plastic or any other light weight corrosion resistant material that can withstand any type of environment or weather including sand, snow, rain, dirt or mud.

8) The bicycle of claim 7, further comprised of an elongated Frame and Fork system, which allows the top of the seat post to be almost equal to the smallest tire heights, further, the seat can be raised as the child grows, constantly being adjusted to fit a child's size, the handlebars will raise equally with the change in the wheel or tire diameter and the front stem can be extended to elevate the handlebars to any required height adjustment.

9) The bicycle of claim 8, further being adaptable to 3 different size tires which are at least 5″ by 12″, 5″ by 16″ and 5″ by 20″

10) The bicycle of claim 9, further housing an interchangeable wheel system comprised of a center wheel or rim with at least a 6″ rim in diameter, which allows for replacement of the tires on the bicycle to suit the size of the growing child.

11) The bicycle of claim 10, further comprised of: fat tire system technology, which is at least a 12″ by 5″ rim, hub and tire/tube with a fork on the bicycle which will accept at least a 20″ by 6″ rim, hub, and tire/tube system;
a minimum of 140 mm 210 mm clearance side post to side post;
a standard size bicycle stem, headset, and handle bar design; and
a single bottom tube to go up from a stem tube to a bottom seat post tube.

12) The bicycle of claim 11, further comprised of a one-size rim and hub system that allows for installation of different sized tires resulting in a different size diameter wheel systems.

13) The bicycle of claim 12, further comprised of the rear chain stay and the rear fork system will be extra wide and long to alloy for at least a 20″ by 6″ rim, hub and tire/tube system. This rear fork will allow for stand, extra wide, single speed coaster bike hub and its hub will have a single speed coaster brake attachment. The rear hub will be a single speed coaster brake steel or stainless steel hub with a low gearing to allow for riding in sandy soil, mud, grass, dirt, or even hard surfaces with ease.
